(19) United States
(12) Patent Application Publication
(10) Pub. No.: US 2005/0283969 A1
(43) Pub. Date: Dec. 29, 2005

(54) Method for assembling head-drum assembly for magnetic recording/reproducing apparatus

(75) Inventors: Chung-Hum Baik, Suwon-si (KR); Byeng-Bae Park, Aansan-si (KR); Myoung-Joon Kim, Suown-si (KR); Jeong-Hyeob Oh, Anyang-si (KR); Seung-Woo Lee, Suwon-si (KR); Hyeong-Seok Choi, Suwon-si (KR); Jae-Hoon Sim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/068,876

(22) Filed: Mar. 2, 2005

(30) Foreign Application Priority Data
Jun. 28, 2004 (KR) 2004-48811

(51) Int. Cl. G11B 5/027

(52) U.S. Cl. 29/603.01; 360/84; 29/603.07

(57) ABSTRACT

A method for assembling a head-drum assembly for a magnetic recording/reproducing apparatus is provided. The head-drum assembly is assembled by inserting a shaft to a fixed drum first, setting up a motor stator in the fixed drum, and putting a rotary drum assembly and drum cover assembly into the shaft sequentially. The method can reduce the number of part to be abandoned due to a defect caused in the assembly process by performing a process of assembling the shaft and the fixed drum first, an area in which most defects are caused, and then proceeding to the subsequent assembly processes.

### CROSS-REFERENCE TO RELATED APPLICATIONS

This application claims the benefit under 35 U.S.C. 119(a) of Korean Patent Application No. 2004-48811 filed Jun. 28, 2004, in the Korean Intellectual Property Office, the entire contents of which is incorporated herein by reference.

### BACKGROUND OF THE INVENTION

1. Field of the Invention:

The present invention relates to a head-drum assembly for a magnetic recording/reproducing apparatus. More particularly, the present invention relates to a method for assembling a head-drum assembly which is used for a magnetic recording/reproducing apparatus such as a small-sized camcorder including a digital video camera (DVC).

2. Description of the Related Art:

Generally, a magnetic recording/reproducing apparatus such as a small-sized camcorder including a digital video camera (DVC), and a videocassette recorder (VCR) comprises a head-drum assembly in the deck. The head-drum assembly includes a magnetic head that is formed to be rotatable at a high-rate and records/reproduces video data by scanning magnetic tape.

FIG. 1 is a cross-sectional view illustrating a head-drum assembly which is set up in a deck of a magnetic recording/reproducing apparatus, i.e., a small-sized camcorder.

As shown in the drawing figure, the head-drum assembly 100 comprises a rotary drum 110, a fixed drum 120, and a drum cover 130.

The rotary drum 110 is set up in a shaft 140 to be rotatable and support a magnetic head (h) for recording/reproducing video data by scanning magnetic tape (not shown) that runs on the rotary drum 110.

The fixed drum 120 and the drum cover 130 are press-fitted over the lower and upper parts of the shaft 140 respectively with the rotary drum 110 placed therebetween.

The drum cover 130 is disposed in the upper part of the rotary drum 110, which is shown in FIG. 2. The drum cover 130 includes a conductive bush unit 131, a cover unit 132, and a grounding plate 133.

The bush unit 131 is shaped in a flange to which the shaft 140 is press-fitted. The cover unit 132 is formed using a resin molding method to be connected with the bush unit 131 by a pair of screws S. Then, the grounding plate 133 is supported by any one of the screws (S) to be exposable on the top surface of the cover unit 132, and it is electrically connected to a sub-circuit substrate 153.

Between the rotary drum 110 and the drum cover 130, a pair of rotation transformers 151 and 152 are formed proximately to each other to communicate signals with the magnetic head (h) and the sub-circuit substrate 153, individually.

A motor rotor 160 including a doughnut-shaped magnet 162 in an annular rotor case 161 is disposed on the bottom surface of the rotary drum 110, and a motor stator 170 is disposed on the top surface of the fixed drum 120. The motor stator 170 is fabricated by forming a three-layer fine pattern (FP) coil in a disk shape and placing the disk in close proximity to the doughnut-shaped magnet 162. Reference numerals ‘140a’ and ‘140b’ denote upper and lower bearings, respectively, and a reference numeral ‘141’ denotes a preload spring.

The conventional head-drum assembly 100 with the above-described structure is assembled by putting together the shaft 140 and the rotary drum 110 first, inserting the rotary drum 110 with the shaft 140 to the fixed drum 120, and then putting the drum cover 130 on the top surface of the rotary drum 110 with the fixed drum 120.

More specifically, the shaft 140 is press-fitted into the upper bearings 140a and the upper bearings 140a with the shaft 140 is housed by a bearing housing formed in the upper part of the rotary drum 110. Then, the preload spring 141 and the lower bearings 140b are set up in the inside of the rotary drum 110 as shown in FIGS. 1 and 2. After the shaft 140 and the rotary drum 110 are assembled, the magnetic head (h) and the motor rotor 160 are set up in the bottom surface of the rotary drum 110 sequentially, and a rotation transformer 152 is placed on the top surface.

Subsequently, the fixed drum 120 is assembled with the rotary drum 110 having the shaft 140 press-fitted by setting up the motor stator 170 at a position in confrontation with the motor rotor 160. Herein, the rotary drum 110 and the fixed drum 120 are assembled by forcedly fitting the shaft 140 to the rotary drum 110 and the fixed drum 120. Then, the drum cover 130 is joined with the bush member 131 in the upper part of the rotary drum 110 assembled with the fixed drum 120.

However, the process of inserting the shaft 140 to the fixed drum 120 is generally performed using a cold pressure insertion, which causes a high defect rate. Once a defect is caused during the insertion process, all the parts set up in the rotary drum 110 and the fixed drum 120 should be abandoned. Therefore, the economic loss due to the abandonment of defective parts is huge, and some improvement is required.

### SUMMARY OF THE INVENTION

It is, therefore, an object of the present invention to provide a method for assembling a head-drum assembly for a magnetic recording/reproducing apparatus. The method simplifies the assembly process and minimizes the number of parts that are abandoned when a defect is caused during an assembly process.

In accordance with an aspect of the present invention, there is provided a method for assembling a head-drum assembly which includes a fixed drum assembly, a rotary drum assembly, and a shaft for supporting the rotary drum assembly to be rotatable with respect to the fixed drum assembly and used for a magnetic recording/reproducing apparatus. The method comprises assembling the fixed drum assembly with the shaft by press-fitting the shaft; and assembling the shaft with the rotary drum assembly by inserting bearings.

The fixed drum assembly includes a fixed drum, a yoke which comprises a silicon steel plate set up in the fixed drum, and a two-layer fine pattern (FP) coil which is set up in the yoke and forms a motor stator.

The rotary drum assembly comprises a rotary drum, upper and lower bearings press-fitted into the inner circumference of the rotary drum, a magnetic head, a rotation transformer which is connected with the magnetic head and set up in the top surface of the rotary drum, and a motor rotor which is formed proximately to the motor stator in the lower part of the rotary drum.

Herein, the motor rotor comprises a rotor case fixed to the rotary drum; and a magnet fixed to the rotor case. The rotor case is a plane having a ring shape.

In accordance with another aspect of the present invention, there is provided a method for assembling a head-drum assembly for a magnetic recording/reproducing apparatus. The method comprises assembling a fixed drum assembly and a rotary drum assembly; assembling a shaft with the fixed drum assembly; assembling the rotary drum assembly with the shaft to be rotatable; and assembling a drum cover assembly with the shaft protruding from the upper part of the rotary drum assembly.

In the process of assembling the fixed drum assembly, the shaft is press-fitted into a fixed drum and a fine pattern (FP) coil which comprises two layers and forms a yoke. A motor stator is bonded to the fixed drum.

Also, the process of assembling the rotary drum assembly comprises preparing a rotary drum; inserting upper and lower bearings to the inner circumference of the rotary drum; setting up a magnetic head in the rotary drum; setting up a first rotation transformer in the rotary drum and connecting the first rotary transformer set up in the rotary drum with the magnetic head; and setting up a motor rotor in the rotary drum.

The motor rotor includes an annular rotor case having a plane structure, a magnet installed in the rotor case. The rotor case is bonded to the rotary drum while the magnet is bonded to the rotor case.

The drum cover assembly includes a drum cover, a second rotation transformer proximate to the first rotation transformer, and a sub-circuit substrate, and the drum cover assembly is press-fitted into the shaft with a preload spring inserted between the upper bearing and the drum cover assembly.

The aspects of the present invention described above can reduce the economic loss caused by a defective part by performing a process of assembling the fixed drum and the shaft, in which most defects are caused, first and, if a defect is generated during the assembling process, only abandoning the fixed drum and the shaft.

### BRIEF DESCRIPTION OF THE DRAWINGS

The above aspects and features of the present invention will be more apparent by describing certain embodiments of the present invention with reference to the accompanying drawings, in which:

FIG. 1 is a cross-sectional view illustrating a conventional head-drum assembly;

FIG. 2 is an exploded perspective view illustrating the head-drum assembly of FIG. 1;

FIG. 3 is a cross-sectional view illustrating a head-drum assembly in accordance with an embodiment of present invention; and

FIGS. 4A to 4C are cross-sectional views illustrating an example for assembling the head-drum assembly sequentially in accordance with an embodiment of the present invention.

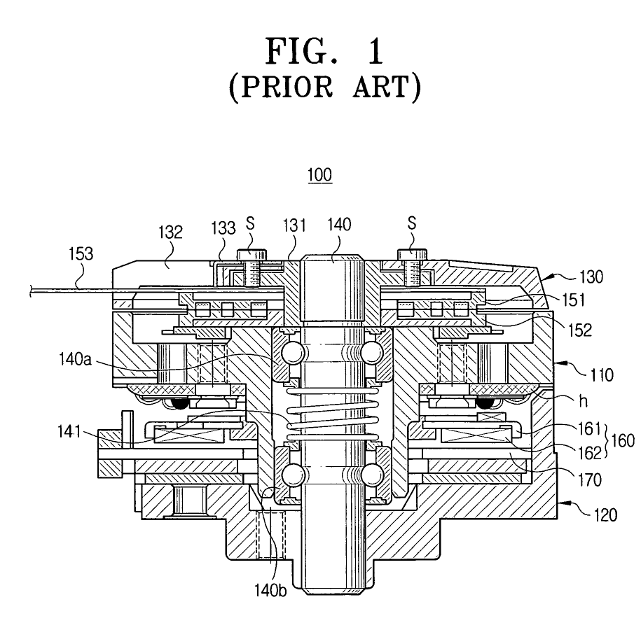

### DETAILED DESCRIPTION OF THE PREFERRED EMBODIMENTS

Certain embodiments of the present invention will be described in greater detail with reference to the accompanying drawings.

The matters defined in the description such as a detailed construction and elements are exemplary. Thus, it should be apparent that the present invention can be performed without the specific examples. Also, well-known functions or constructions are not described in detail for conciseness.

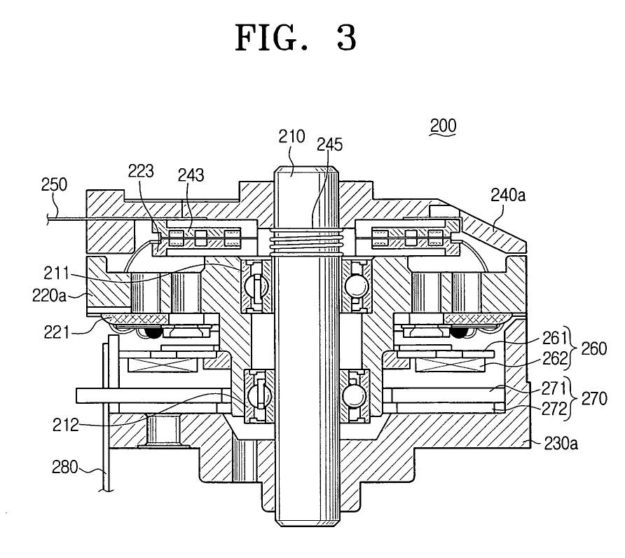

FIG. 3 is a cross-sectional view illustrating a head-drum assembly 200 for a magnetic recording/reproducing apparatus in accordance with an embodiment of the present invention.

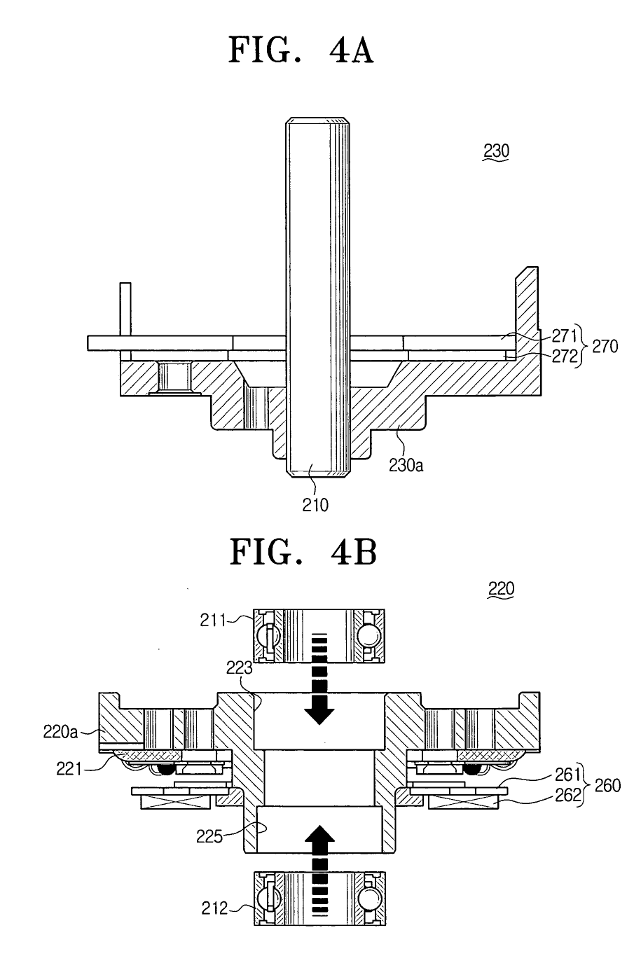

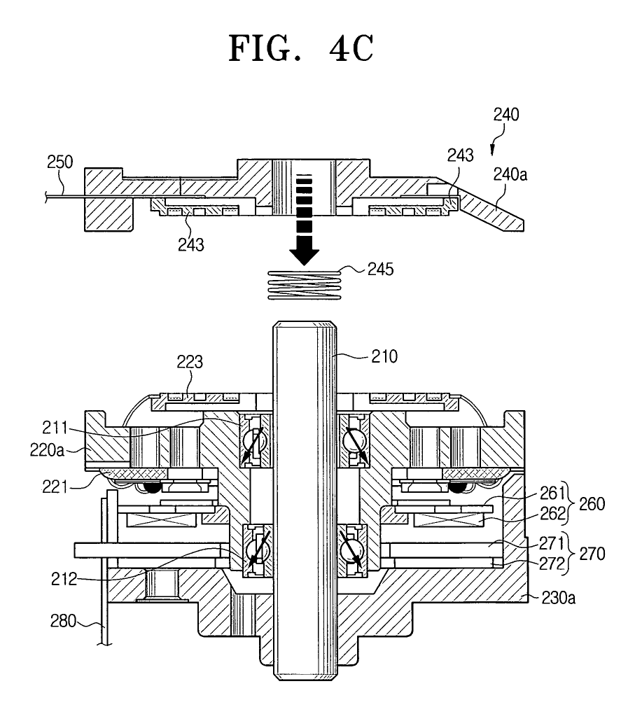

As shown in the drawing, the head-drum assembly 200 comprises a shaft 210, a rotary drum assembly 220 (see FIG. 4B), a fixed drum assembly 230 (see FIG. 4A), and a drum cover assembly 240 (see FIG. 4C).

The shaft 210 supports the rotary drum assembly 220, the fixed drum assembly 230, and the drum cover assembly 240 by being in the rotational center of the rotary drum assembly 220, the fixed drum assembly 230, and the drum cover assembly 240.

The rotary drum assembly 220 includes a rotary drum 220a, a magnetic head 221, a first rotation transformer 223, and a motor rotor 260.

The rotary drum 220a is set up to be rotatable by upper and lower bearings 211 and 212 with respect to the shaft 210. Herein, it is preferred that the upper and lower bearings 211 and 212 have the same inner diameter.

The magnetic head 221 reads video data by scanning a magnetic tape (not shown). The magnetic head 221 is connected to the first rotation transformer 223.

The first rotation transformer 223 communicates signals with a second rotation transformer 243 which is set up in a position corresponding to the drum cover assembly 240 to thereby transmit the signals from the magnetic head 221 to a sub-circuit substrate 250, which will be described below.

The motor rotor 260 includes an annular rotor case 261 and a magnet 262. The annular rotor case 261 is a plane fabricated without requiring an additional process such as bending, and the magnet 262 is formed in the shape of a doughnut and bonded to the lower part of the annular rotor case 261.

The fixed drum assembly 230 includes a fixed drum 230a and a motor stator 270. The fixed drum 230a is positioned under the rotary drum 220a. The motor stator 270 is set up on the top surface of the fixed drum 230a and includes a fine pattern (FP) coil 271 and a yoke 272.

The FP coil 271 is formed in the shape of a disk having two layers and proximal to the doughnut-shaped magnet 262. The yoke 272 is set up to prevent Eddy Current Loss phenomenon of a magnetic field that is formed in the bottom surface of the FP coil 271. Preferably, the yoke 272 comprises a silicon steel plate.

If the yoke 272 comprises a silicon steel plate, the material cost can be reduced while the same performance is achieved, compared to a conventional ferrite yoke. In the drawing, a reference numeral ‘280’ denotes a motor FPC that conveys a control signal to the motor stator 270.

The drum cover assembly 240 includes a drum cover 240a, a second rotation transformer 243, and a sub-circuit substrate 250.

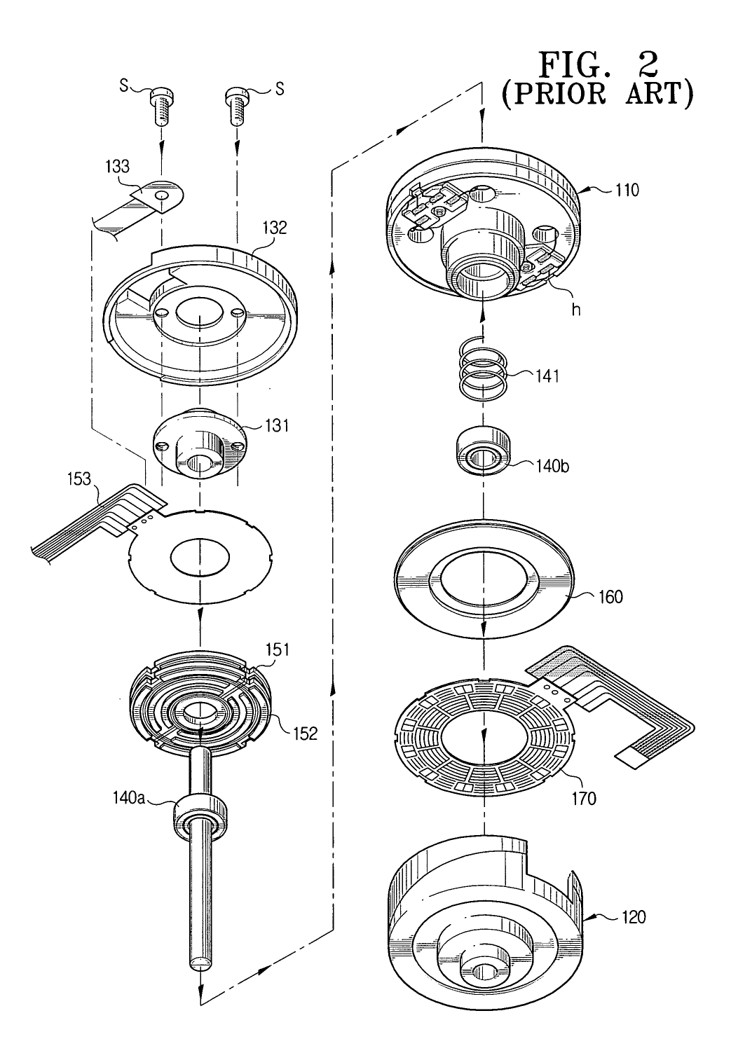

As shown in FIG. 2, the drum cover 240a is positioned in and connected with the upper part of the rotary drum 220a by the shaft 210 press-fitted thereto. The sub-circuit substrate 250 in the inside of the drum cover 240a is positioned to be connected with the second rotation transformer 243. Meanwhile, since the sub-circuit substrate 250 has a ground line positioned therein, it does not require an additional ground screw.

Hereafter, a method for assembling a head-drum assembly for a magnetic recording/reproducing apparatus, which is suggested in an embodiment of the present invention, will be described with reference to FIGS. 4A to 4C.

The first step of the head-drum assembly assembling method, according to an embodiment of the present invention is to insert the shaft 210 to the fixed drum 230a by using a cold pressure insertion method, which is illustrated in FIG. 4A. Herein, if a defect is caused during the process of inserting the shaft 210 to the fixed drum 230a, the parts of the defect are abandoned. Only when the shaft 210 is connected with the fixed drum 230a normally, the motor stator 270 is positioned in the fixed drum 230a to thereby form a fixed drum assembly. Herein, the yoke 272 is bonded onto the fixed drum 230a, and then the FP coil 271 is bonded onto the top surface of the yoke 272.

Subsequently, as shown in FIG. 4B, the rotary drum assembly 220 is assembled. The upper and lower bearings 211 and 212 are press-fitted into the bearing housings 223 and 225 formed in the upper and lower part of the rotary drum 220a, and the magnetic head 221 is formed at a predetermined position. Then, the first rotation transformer 223 is formed in the upper part of the rotary drum 220a to be connected with the magnetic head 221, and the motor rotor 260 is positioned in proximity to the motor stator 270 in the lower part of the rotary drum 220a.

Subsequently, as illustrated in FIG. 4C, the fixed drum 230a with the shaft 210 press-fitted thereto is connected with the rotary drum 220a which is prepared as shown in FIG. 4B. Herein, the shaft 210 is inserted onto the upper and lower bearings 211 and 212 formed in the rotary drum 220a using the cold pressure insertion method.

As shown in FIG. 4C, the drum cover assembly 240 is set up in the upper part of the rotary drum 220a connected with the fixed drum 230a. Herein, in the process of assembling the rotary drum assembly 220 with the fixed drum assembly 230, pressure is applied to the inner hub of the upper and lower bearings 211 and 212 as the shaft 210 is press-fitted. Due to the pressure by the insertion of the shaft 210, the inner and outer hubs of the bearings may deviate. In order to prevent the deviation, the preload spring 245 is inserted between the rotary drum 220a and the drum cover 240a. The preload spring 245 pressures the inner hub in the direction of the arrow which is illustrated in FIG. 4C to thereby arrange the inner and outer hubs of the upper and lower bearings 211 and 212.

As described above, if the shaft 210 is inserted onto the fixed drum 230a without the motor stator 270 installed yet and if a defect is caused during the shaft insertion, only the shaft 210 and the fixed drum 230a need to be abandoned. Therefore, the number of parts to be abandoned is reduced, compared to the conventional head-drum assembly.

In accordance with the embodiment of the present invention which is described above, the number of parts that are abandoned due to a defect caused in the process of assembling the shaft and the fixed drum is reduced. Therefore, less parts are wasted and the assembling cost can be reduced.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A method for assembling a head-drum assembly which includes a fixed drum assembly, a rotary drum assembly, and a shaft for supporting the rotary drum assembly to be rotatable with respect to the fixed drum assembly and used for a magnetic recording/reproducing apparatus, comprising the steps of:
assembling the fixed drum assembly with the shaft by press-fitting the shaft; and
assembling the shaft with the rotary drum assembly by inserting bearings.

2. The method as recited in claim 1, wherein the fixed drum assembly comprises a fixed drum, a yoke which comprises a silicon steel plate set up in the fixed drum, and a two-layer fine pattern (FP) coil which is set up in the yoke and forms a motor stator.

3. The method as recited in claim 2, wherein the rotary drum assembly comprises a rotary drum, upper and lower bearings press-fitted into the inner circumference of the rotary drum, a magnetic head, a rotation transformer which is connected with the magnetic head and set up in the top surface of the rotary drum, and a motor rotor which is formed proximal to the motor stator in the lower part of the rotary drum.

4. The method as recited in claim 3, wherein the motor rotor comprises: a rotor case fixed to the rotary drum; and a magnet fixed to the rotor case.

5. The method as recited in claim 4, wherein the rotor case is a plane having a ring shape.

6. A method for assembling a head-drum assembly for a magnetic recording/reproducing apparatus, comprising the steps of:
assembling a fixed drum assembly and a rotary drum assembly;
assembling a shaft with the fixed drum assembly;
assembling the rotary drum assembly with the shaft to be rotatable; and
assembling a drum cover assembly with the shaft protruding from the upper part of the rotary drum assembly.

7. The method as recited in claim 6, wherein, in the step of assembling the fixed drum assembly, the shaft is press-fitted into a fixed drum and a fine pattern (FP) coil which comprises two layers and forms a yoke.

8. The method as recited in claim 7, wherein a motor stator is bonded to the fixed drum.

9. The method as recited in claim 6, wherein the step of assembling the rotary drum assembly comprises the steps of:
preparing a rotary drum;
inserting upper and lower bearings to the inner circumference of the rotary drum;
setting up a magnetic head in the rotary drum; and
setting up a first rotation transformer in the rotary drum and connecting the first rotary transformer set up in the rotary drum with the magnetic head; and
setting up a motor rotor in the rotary drum.

10. The method as recited in claim 9, wherein the motor rotor includes an annular rotor case having a plane structure, a magnet installed in the rotor case.

11. The method as recited in claim 10, wherein the rotor case is bonded to the rotary drum while the magnet is bonded to the rotor case.

12. The method as recited in claim 9, wherein the drum cover assembly comprises a drum cover, a second rotation transformer proximate to the first rotation transformer, and a sub-circuit substrate, and the drum cover assembly is press-fitted into the shaft with a preload spring inserted between the upper bearing and the drum cover assembly.
